(19) United States
(12) Patent Application Publication
(10) Pub. No.: US 2026/0106407 A1
(43) Pub. Date: Apr. 16, 2026

(54) RIGHT-ANGLE ELECTRICAL CONNECTOR WITH A MATE ASSIST SYSTEM

(71) Applicant: Aptiv Technologies AG, Schaffhausen (CH)

(72) Inventors: Fabrice DEMOMENT, NOGENT LE ROI (FR); Philippe GOUBAND, CHARPONT (FR); Frederic BELLIARD, TREMBLAY-LES-VILLAGES (FR)

(21) Appl. No.: 19/357,207

(22) Filed: Oct. 14, 2025

(30) Foreign Application Priority Data
Oct. 14, 2024 (EP) 24206514.2

(51) Int. Cl. H01R 13/631

(52) U.S. Cl. CPC H01R 13/631

(57) ABSTRACT

An electrical connector includes one or more electrical terminals accommodated in a housing having a mating interface for connection to a counter-connector and an outlet for cable exit. A mate assist system facilitates joining the connector to the counter-connector. The system includes a user-operable element slidably mounted on the housing for movement between open and closed positions along an operating direction perpendicular to the cable exit direction. The system further includes at least one rack section extending parallel to the operating direction. The system also includes at least one rotatable cam member having a cam slot to receive a mounting pin from the counter-connector and a gear section with teeth engaging the rack section. Upon actuation of the user-operable element from open to closed, meshing of the gear and rack rotates the cam member to guide the terminals into mating engagement.

### CROSS-REFERENCE TO RELATED APPLICATION

This application claims the benefit of and priority to European Application No. 24206514.2 filed with the European Patent Office on Oct. 14, 2024, the contents of which are incorporated by reference herein.

### TECHNICAL FIELD

The present disclosure relates to an electrical connector and, more particularly, to a system for mating two electrical connectors with each other.

### BACKGROUND

When cables with a large section are connected to the terminals, the cable harness becomes quite rigid. Further, the cables may be short and/or sometimes there is little room around the connector and the mating counter-connector. Then the bending of the cables may be difficult and as a consequence, it can be difficult to find a proper alignment of the connector and the mating connector along the mating direction.

Further, when the connector and the counter-connector are not properly aligned along the mating direction, not only is the mating of the connector the counter-connector less easy (resulting from high efforts generated by the connector misalignment during the mating phase), but the reliability and the quality of the electrical contact between the terminals, as well as the reliability of possible sealing means, are not optimized due to the fact that the connector and the counter-connector may not be well aligned. Similarly, when the electrical connector and the counter-connector are EMI shielded, the shielding continuity can also be deteriorated.

An aim of the disclosure is to propose a connector and/or a connector assembly that mitigate at least partially the problems encountered with the prior art connectors.

### SUMMARY

In some respects, the techniques described herein relate to an electrical connector, including one or more electrical terminals and a housing in which the electrical terminals are accommodated. The housing has a mating interface configured to access the electrical terminals for an electrical connection of the electrical terminals with corresponding terminals of an electrical counter-connector configured to mate with the electrical connector. The housing also has an outlet from which cables electrically connected to the electrical terminal of the electrical connector exits in an exit direction. The electrical connector additionally includes a mate assist system for assisting in mating the electrical connector to the counter-connector. The mate assist system includes a user-operable element slidably mounted on the housing so as to slide, along an operating direction, between an open position and a closed position, at least one first rack section extending parallel to the operating direction, and at least one first rotatable cam member including a cam slot for receiving a first mounting pin extending from a first side of the counter-connector. The first cam member has a first gear section with teeth engaging the first rack section. The engagement of the teeth with the first rack section results in the rotation of the first cam member in a first direction of rotation when the user-operable element is actuated from the open position to the closed position. The operating direction is perpendicular to the exit direction.

In some respects, the techniques described herein relate to an electrical connector, including one or more electrical terminals and a housing in which the electrical terminals are accommodated. The housing has a mating interface configured to access the electrical terminals for an electrical connection of the electrical terminals with corresponding terminals of an electrical counter-connector configured to mate with the electrical connector. The electrical connector further includes a mate assist system for assisting in mating the electrical connector to the counter-connector electrical connector. The mate assist system further includes a user-operable element slidably mounted on the housing so as to slide, along an operating direction, between an open position and a closed position, at least one rack section extending parallel to the operating direction, and at least one rotatable cam member having a gear section with teeth engaging the rack section. The engagement of the teeth with the rack section results in the rotation of the cam member when the user-operable element is actuated from the open position to the closed position. The rotatable cam member includes a flexible blocking leg configured to flex from a blocking position in which it engages the housing to prevent the user-operable element from moving to its closed position, to a release position in which it disengages from the housing to allow a movement of the user-operable element from its open position to its closed position. The movement from the blocking position to the release position of the blocking leg is caused by engagement of the counter-connector with the blocking leg.

One of the most important advantages of the disclosed connector, is that since the operating direction of the user-operable element is not aligned with the cables exiting from the housing outlet, it is no longer necessary to have a user-operable element which has a general tubular shape and it becomes possible to provide the user-operable element with an actuating wall which is perpendicular to the operating direction. From an ergonomic point of view, a configuration in which the operator can press or push on the actuating wall of the user-operable element, for example with the palm of the hand, this actuating wall being substantially perpendicular to the direction of actuation, is much more comfortable and easier to use than a configuration in which an operator must hold the user-operable element between the fingers and thumb and with the hand not in comfortable alignment with the arm.

In addition, the fact that the direction of operation is perpendicular to the direction in which the cables exit from the housing outlet (or rear side) of the connector, can help to avoid having to bend potentially very stiff cables, or at least can help to limit the bending of such cables.

According to another aspect, it is disclosed below a connector with a mate assist system having at least two gear cams. Thanks to such a double mate-assist system (two cam members/two mounting pins) the robustness of the connector assembly is increased.

Thanks to the engagement of a cam member and a mounting pin, symmetrically arranged, on opposite sides of the connectors, the mating forces that draw the connectors towards and into each other are the same on both these opposite sides. Further, as a consequence of the opposed rotation directions of the cam members, the torque applied on one face of the housing is balanced by the torque applied on the opposite face. Therefore, any possible rock and tilt the connector with respect to the mating connector is cancelled. Hence, the connector and the counter-connector slide into each other respectively in parallel directions.

According to another aspect, it is disclosed below a connector according to claim 12 and an electrical connector assembly according to claim 14.

It should be noted that the rotating cam member with a flexible locking leg can be used in a straight connector and not exclusively in a right-angle connector (as illustrated below). These two features (the flexible locking leg and the direction of operation perpendicular to the direction of output) are independent of each other and protection can be sought separately for either or both of these two features.

Other features of these connectors and connector assembly are mentioned in the dependent claims, considered separately from one another, or each one considered in combination to one or several other features.

### BRIEF DESCRIPTION OF THE DRAWINGS

Possible embodiments are described in more detail in the following detailed description with reference to the following figures.

FIG. 1 is a schematic isometric view of an electrical connector, with a user-operable element in open position according to some embodiments.

FIG. 2 is a schematic isometric view of the electrical connector shown in FIG. 1, this electrical connector being fully mated with a counter-connector, to form a connector assembly, the user-operable element being in closed position according to some embodiments.

FIG. 3 is a schematic isometric view, of the connector assembly of FIG. 2, with the user-operable element in open position and a lateral wall of the user-operable element partially removed in particular to show a cam member according to some embodiments.

FIG. 4 is a schematic partial cross-section, parallel to the operating direction, of the housing and the user-operable element of the connector shown in FIGS. 1 to 3, the user-operable element being in open position according to some embodiments.

FIG. 5 is a schematic isometric view of a cam member of the connector shown in FIGS. 1 to 3 according to some embodiments.

FIG. 6 is a schematic partial cross-section, parallel to the operating direction, of the housing and the user-operable element of the connector shown in FIGS. 1 to 3, this cross-section showing in particular the engagement of a cam member, on the one hand, with a rack section of the user-operable element, and on the other hand with the connector housing according to some embodiments.

FIG. 7 is a schematic partial cross-section, perpendicular to the operating direction, of the housing and the user-operable element of the connector shown in FIGS. 1 to 3 according to some embodiments.

### DETAILED DESCRIPTION

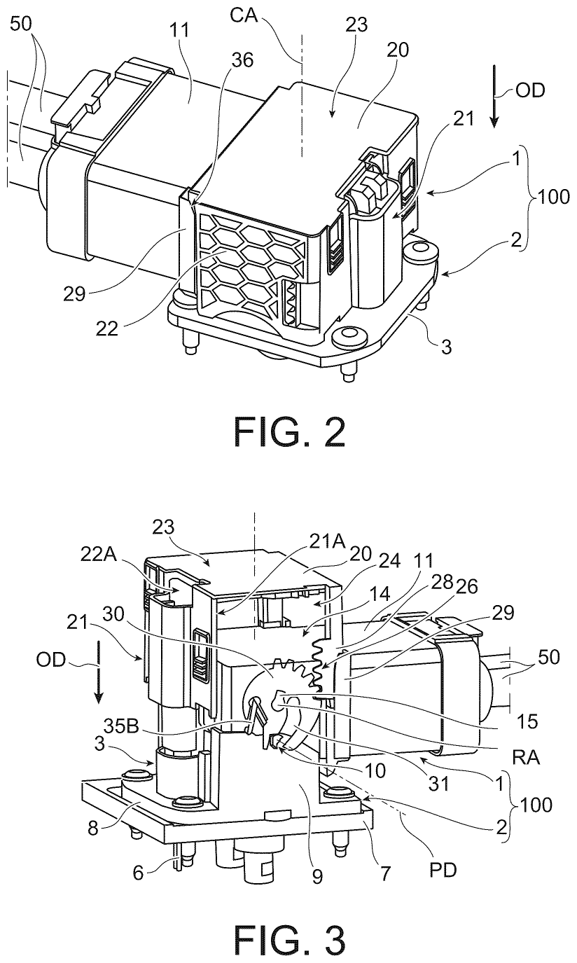

An example of a connector assembly 100 is shown in FIGS. 2 and 3. This connector assembly 100 comprises a connector 1 and a mating connector or counter-connector 2. The connector 1 and counter-connector 2 are intended to transmit electrical currents having an intensity ranging from 250 Amps to 600 Amps for example. In FIG. 2, the connector 1 and the counter-connector 2 are mated, and the user-operable element 20 is in the closed position. In FIG. 2, the connector 1 and the mating connector 2 are unmated, the user-operable element 20 is in the rear position.

The counter-connector 2 is for example a male connector with a dielectric housing 3 accommodating two male power terminals extending longitudinally parallel to an operating or mating direction OD. Each terminal has a connection end (not shown) intended to be mated with a female power terminal (not shown) accommodated in the housing 11 of the connector 1. The counter-connector 2 also comprises interlock terminals (not shown) electrically linked to signal wires 6.

The housing 3 is made of molded plastics. The housing 3 accommodates each one of the male power terminals in a separate cavity. The housing 3 comprises a flange 8 for mounting the counter-connector 2 onto a wall 7, a box or any other equipment. The housing 3 comprises walls 9 extending parallel to the operation direction OD, perpendicular to the flange 8. For example, the walls 9 form a generally tubular shape (for example with a rectangular cross-section). The housing 3 comprises two mounting pins 10 integrally formed with walls 9. For example, each mounting pin 10 extends radially and outwardly perpendicular to the operation direction OD, from a wall 9. The two mounting pins 10 are, for example, aligned to each other on the same axis PD and protrude from the housing 3 in opposite directions along this same axis PD, from two opposite walls 9 (see FIG. 3). Shielding and sealing means (not shown) are mounted to the counter-connector 2.

The connector 1 comprises in addition to the housing 11 and the two female power terminals accommodated in the housing 11, at least a user-operable element 20 (or slider), and two cam members 30. The female power terminals are electrically linked to cables 50 with cross sections ranging, for example, between 35 to 95 square millimetres (and possibly even higher). Shielding and sealing means are mounted to the connector 1. The housing 11, the user-operable element 20 and the two cam members 30 are made of dielectric material (molded plastics). The two cam members 30 are identical. This reduces the number of different parts to be manufactured and managed. They can be manufactured in the same mold cavity.

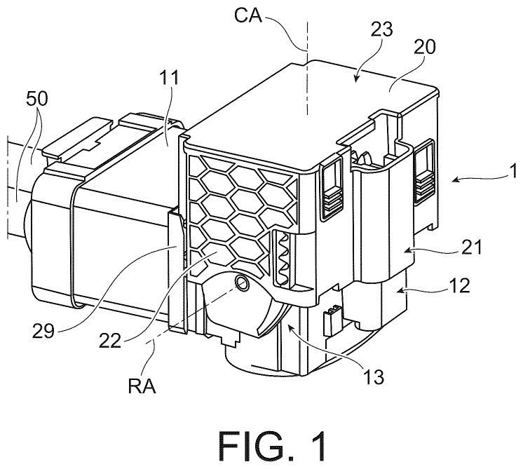

As shown in FIGS. 1 to 3, the user-operable element 20 has four walls: one front wall 21, two lateral walls 22 and an upper wall or actuating wall 23. The front wall 21 and the two lateral walls 22 essentially extend in planes parallel to a longitudinal central CA. The central axis CA is parallel to the operation direction OD. The actuating wall 23 essentially extend perpendicular to the operation direction OD. The actuating wall 23 is advantageously large and essentially flat. The actuating wall 23 is configured to be pushed to move the user-operable element 20 from an open position (see FIGS. 1 and 3), which corresponds to the delivery position, to a closed position (see FIG. 2) which corresponds to the respective position of the connector 1 and the counter-connector 2 when they are fully mated (in other words, the closed position corresponds to the respective position of the connector 1 and the counter-connector 2 in the connector assembly 100). The front wall 21 and the two lateral walls 22 define a generally rectangular cross-section. An opening 24 is left, opposite the front wall 21, between two lateral walls 22. The front wall 21 has an inner surface 21A and each one of the two lateral walls 22 has an inner surface 22A. Two adjacent walls chosen among the front wall 21 and the two lateral walls 22 are perpendicular to each other and define a corner. The first rack section 25 is located on the corner between one of the lateral walls 22 and the front wall 21. A second rack section 26 is located on a lateral wall 22 opposite the lateral on which the first rack section 25 is located. In other words, the first 25 and second 26 rack sections are located respectively on an inner surface of the user-operable element 20 and generally symmetrically arranged with regard to the longitudinal central axis CA.

The first rack section 25 has teeth 27 extending parallel to the lateral walls 22 in a direction from the front wall 21 towards the opening 2. The second rack section 26 has teeth 27 extending parallel to the lateral walls 22 in a direction from the opening 24 towards the front wall 21.

The user-operable element 20 forms a slider which is guided along the operation direction OD by rails 28 slidably engaged in first reinforcement ramps 29 protruding on the outer surfaces of the housing 11 (see FIGS. 1, 2 and 7). The first reinforcement ramps 29 are configured to cooperate with external faces of the user-operable element 20, these external faces being perpendicular to the rotation axis RA. The user-operable element 20 is also guided along the operation direction OD with second reinforcement ramps 39 protruding on the outer surface of the housing 11 (see FIG. 7). The second reinforcement ramps 39 are configured to cooperate with respective guiding ramps 38 extending longitudinally parallel to the operating direction OD on the front inner surface 21A of the user-operable element 20, this front inner surface 21A being parallel to the rotation axis RA. The first 29 and second 39 reinforcement ramps, the rails 28 and the guiding ramps 38 help stabilizing the user-operable element 20 in particular in the open position. The first 29 and second 39 reinforcement ramps, the rails 28 and the guiding ramps 38 also help preventing, or at least limiting, the vibrations of the user-operable element 20 in the closed position. The first 29 and second 39 reinforcement ramps have slanted edges configured so as to help mounting the user-operable element 20 on the housing 11. This has the advantage of offering a wider choice of plastics that can be used to manufacture the user-operable element 20 and the housing 11 (a question of tolerances and ease of sliding the surfaces together).

When the user-operable element 20 is mounted to the housing 11 and placed in closed position (see FIG. 2), its front wall 21 and lateral walls 22 partially cover respectively a front outer surface 12 and lateral outer surfaces 13 of the housing 11, which are parallel to the operation direction OD. The user-operable element 20 in closed position has its actuating wall 23 partially covering an upper outer surface 14 of the housing 11.

Each cam member 30 (see FIG. 5) is rotatably mounted onto a respective lateral outer surface 13 of the housing 11. Each cam member 30 is mounted on a lateral wall 22, the lateral wall being for example smaller than the front wall 21. When the user-operable element 20 is in closed position (see FIG. 2), each cam member 30 is located between a lateral outer surface 13 and the inner surface 22A of a lateral wall 22, of the user-operable element 20.

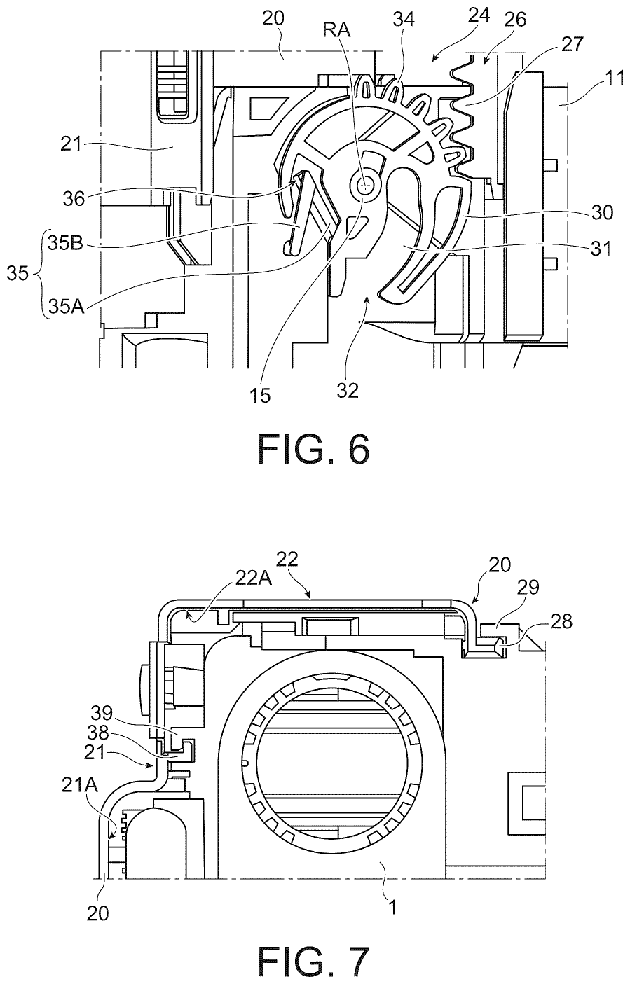

As shown in FIGS. 3 and 6, each cam member 30 rotates about a fulcrum 15 outwardly extending from a lateral outer surface 13. Each cam member 30 has a curved cam slot 31 opened on an inlet 32 (see FIG. 6). When the connector 1 and the counter-connector 2 are in the process of being mated, each cam slot 31 receives a mounting pin 10 extending from a side of the counter-connector 2 (see FIG. 3). Each cam member 30 has a gear section 33 with teeth 34 configured so as to engage the teeth 27 of a corresponding rack section 25 or 26.

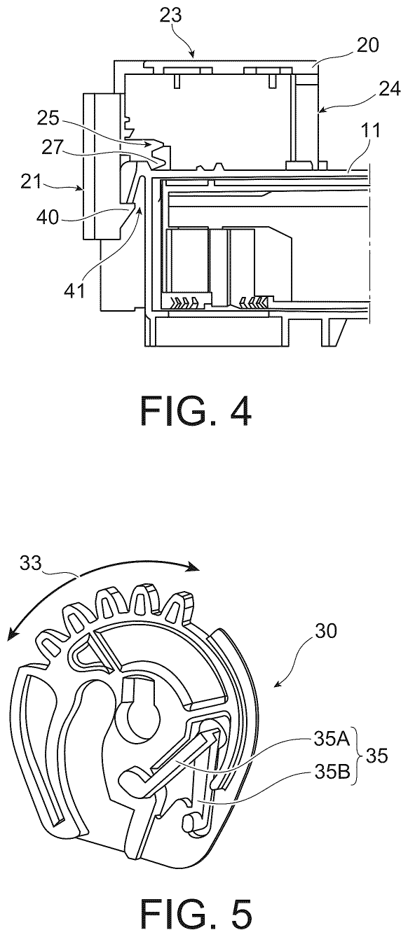

When the user-operable element 20 is mounted on the housing 11, the user-operable element 20 is first blocked in the open position. Indeed, each rotatable cam member 30 comprises a flexible blocking leg 35 configured to engage the housing 11 so as to prevent the user-operable element 20 from moving from its open position towards its closed position. Further, locking means 40 located for example on the user-operable element 20 (see FIG. 4) engage a notch 41 of the housing 11 so as to prevent the user-operable element 20 from being removed from the housing 11.

More particularly, each rotatable cam member 30 comprises a flexible blocking leg 35 configured to flex from a blocking position to a release position. In the blocking position, the flexible blocking leg 35 engages the housing 11 (see FIG. 6) to prevent the user-operable element 20 from moving (or to be moved) from its open position to its closed position. In the release position, the flexible leg 35 disengages from the housing 11 to allow the movement of the user-operable element 20 from its open position to its closed position. The movement from the blocking position to the release position of the blocking leg 35 is caused by engagement of the counter-connector 2 with the blocking leg 35. Indeed, more particularly, the flexible blocking leg 35 comprises a first 35A and a second 35B portions. The first portion 35A extends essentially longitudinally between two longitudinal ends. The first portion 35A is configured so as to bear with one of its longitudinal ends against a stop surface 36 of the housing 11, when the flexible leg 35 is in the blocking position. The second portion 35B extends essentially longitudinally between two ends as well. The second portion 35B is configured to co-operate with a surface (in the present case an upper edge) of the housing 3 of the counter-connector 2 (see FIG. 3) so as to force the first portion 35A away from the stop surface 36, when the connector 1 and counter-connector 2 are mated.

When the connector 1 is directed towards the counter-connector 2, the connector 1 and the counter-connector 2 are oriented with regard to each other so that each mounting pin 10 faces a corresponding cam member inlet 32. Advantageously the user holds the connector 1 by the user-operable element 20 which is in its open position. When moving the connector 1 and the counter-connector 2 further towards each other, each mounting pin 19 enters a cam slot 31. To do this, the user advantageously presses the actuating wall 23 in the operating direction OD. When an upper edge 37 of the housing 3 engages the second portion 35B of the flexible leg 35, there is a resistance in the movement of the respective housings of the connector and counter-connector toward each other. Then, if the user-operable element 20 is pushed further towards its closed position, the first portion 35A of the flexible leg 35 is pushed away from the stop surface 36 and the movement of the user-operable element 20 towards its closed position is released. The first 25 and second 26 rack sections engage the teeth 34 respectively of the first and second cam members 30. As a result, each cam member 30 rotates and the mounting pins 10 are urged and guided in their respective cam slot 31.

Secondary locking means can be provided to lock the connector 1 and the counter-connector 2 in the fully mated position (the user-operable element 20 being in its closed position).

Many variations of the embodiment disclosed above can be envisioned. The connector assembly 100 can be with or without EMI shielding, and /r with or without sealing means. For example,
the cam members 30 can be mounted on the user-operable element 10 and the rack sections 24, 25 can be mounted on the connector housing 11.
the connector 1 can have a third rack section and a third rotatable cam member; the third rotatable cam member being arranged on a surface which is perpendicular to the outer surfaces onto which are mounted the first and second rotatable cam members 30.

While the invention has been described with reference to an exemplary embodiment(s), it will be understood by those skilled in the art that various changes may be made, and equivalents may be substituted for elements thereof without departing from the scope of the invention. In addition, many modifications may be made to configure a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc., are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. An electrical connector, comprising:
one or more electrical terminals;
a housing in which the electrical terminals are accommodated, the housing having a mating interface configured to access the electrical terminals for an electrical connection of the electrical terminals with corresponding terminals of an electrical counter-connector configured to mate with the electrical connector, and the housing having an outlet from which cables electrically connected to the electrical terminal of the electrical connector exits in an exit direction;
a mate assist system for assisting in mating the electrical connector to the counter-connector, the mate assist system comprising a user-operable element slidably mounted on the housing so as to slide, along an operating direction, between an open position and a closed position;
at least one first rack section extending parallel to the operating direction; and
at least one first rotatable cam member comprising a cam slot for receiving a first mounting pin extending from a first side of the counter-connector, the first cam member having a first gear section with teeth engaging the first rack section, the engagement of the teeth with the first rack section resulting in the rotation of the first cam member in a first direction of rotation when the user-operable element is actuated from the open position to the closed position, wherein the operating direction is perpendicular to the exit direction.

2. The electrical connector according to claim 1, wherein the user-operable element has an actuating wall extending perpendicular to the operating direction, the actuating wall being configured to be pushed to move the user-operable element from its open position to its closed position.

3. The electrical connector according to claim 1, further comprising:
a second rack section, extending parallel to the operating direction; and
a second rotatable cam member, comprising a cam slot for receiving a second mounting pin extending from a second side of the counter-connector, the second side being opposite to the first side of the counter-connector, the second cam member having a second gear section with teeth engaging the second rack section, the engagement of the teeth of the second gear section with the second rack section resulting in the rotation of the second cam member in a second direction of rotation when the user-operable element is actuated from the open position to the closed position, the first direction of rotation being opposite to the second direction of rotation when the first cam member and the second cam member are seen from a same side of the connector.

4. The electrical connector according to claim 3, wherein the respective cam slots of the first and second cam members have a common cam race and wherein the first and second cam members rotate about a common axis.

5. The electrical connector according to claim 3, wherein the first and second rotatable cam members are identical.

6. The electrical connector according to claim 3, wherein the user-operable element comprises the first and second rack sections and the first and second rotatable cam members are rotatably mounted to the housing.

7. The electrical connector according to claim 3, wherein the first and second rotatable cam members rotate about a rotation axis which is parallel to a direction joining two terminals.

8. The electrical connector according to claim 3, wherein both the first rotatable cam member and a second rotatable cam member comprise a flexible blocking leg configured to flex from a blocking position in which it engages the housing to prevent the user-operable element from moving to its closed position, to a release position in which it disengages from the housing to allow a movement of the user-operable element from its open position to its closed position, the flexing from the blocking position to the release position of the blocking leg being caused by engagement of the counter-connector with the blocking leg.

9. The electrical connector according to claim 8, wherein the flexible blocking leg comprises a first and a second portions, the first portion extending essentially longitudinally between two longitudinal ends and being configured to rest with one of its longitudinal ends against a stop surface of the housing, when the flexible leg is in a blocking position, the second portion extending essentially longitudinally between two ends and being configured to co-operate with a surface of the counter-connector so as to force the first portion away from the stop surface, when the connector and counter-connector are mated.

10. The electrical connector according to claim 1, wherein the housing comprises first reinforcement ramps configured to cooperate with external faces of the user-operable element, these external faces being perpendicular to a rotation axis.

11. The electrical connector according to claim 1, wherein the housing comprises at least one second reinforcement ramps configured to cooperate with a guiding ramp extending longitudinally parallel to the operating direction on an internal face of the user-operable element, this internal face being parallel to a rotation axis.

12. An electrical connector assembly, comprising:
the connector according to claim 1; and
a mated counter-connector, the connector and the counter-connector being mated when the user-operable element is actuated from the open position to the closed position, in the operating direction.

13. An electrical connector, comprising:
one or more electrical terminals;
a housing in which the electrical terminals are accommodated, the housing having a mating interface configured to access the electrical terminals for an electrical connection of the electrical terminals with corresponding terminals of an electrical counter-connector configured to mate with the electrical connector; and
a mate assist system for assisting in mating the electrical connector to the counter-connector electrical connector, the mate assist system further comprising:
a user-operable element slidably mounted on the housing so as to slide, along an operating direction, between an open position and a closed position,
at least one rack section extending parallel to the operating direction, and
at least one rotatable cam member having a gear section with teeth engaging the rack section, the engagement of the teeth with the rack section resulting in the rotation of the cam member when the user-operable element is actuated from the open position to the closed position, wherein the rotatable cam member comprises a flexible blocking leg configured to flex from a blocking position in which it engages the housing to prevent the user-operable element from moving to its closed position, to a release position in which it disengages from the housing to allow a movement of the user-operable element from its open position to its closed position, the movement from the blocking position to the release position of the blocking leg being caused by engagement of the counter-connector with the blocking leg.

14. An electrical connector according to claim 13, wherein the flexible blocking leg comprises a first portion and a second portion, the first portion extending essentially longitudinally between two longitudinal ends and being configured to rest with one of its longitudinal ends against a stop surface of the housing, when the flexible leg is in the blocking position, the second portion extending essentially longitudinally between two ends and being configured to cooperate with a surface of the counter-connector so as to force the first portion away from the stop surface, when the connector and counter-connector are mated.

15. An electrical connector assembly, comprising:
the connector according to claim 13; and
a mated counter-connector, the connector and the counter-connector being mated when the user-operable element is actuated from the open position to the closed position, in the operating direction.
